(19) United States
(12) Patent Application Publication
(10) Pub. No.: US 2011/0246288 A1
(43) Pub. Date: Oct. 6, 2011

(54) METHOD AND SYSTEM FOR MANAGING QUALITY OF ADVERTISED WEBPAGE

(75) Inventors: Ki Oh Kwon, Seongnam-si (KR); Yuwon Kim, Seongnam-si (KR); Won Sook Noh, Seongnam-si (KR); Woongsup Shin, Seongnam-si (KR); Woosung Lee, Seongnam-si (KR); Min Seon Jeon, Seongnam-si (KR); Seojin Han, Seongnam-si (KR); Ha-Nyung Chung, Seongnam-si (KR)

(73) Assignee: NHN BUSINESS PLATFORM CORPORATION, Seongnam-si (KR)

(21) Appl. No.: 13/120,892

(22) PCT Filed: Sep. 30, 2009
(86) PCT No.: PCT/KR2009/005609

§ 371 Date: Jun. 16, 2011

(30) Foreign Application Priority Data
Sep. 30, 2008 (KR) 10-2008-0096099

(51) Int. Cl. G06Q 30/00

(52) U.S. Cl. 705/14.45

(57) ABSTRACT

Disclosed is a method and system for managing quality of an advertising document. The method of managing document quality may include verifying a number of actual clicks corresponding to a number of clicks that may occur during a predetermined period with respect to at least one document that may exist on the Web, verifying a number of expected clicks corresponding to a number of clicks that may be expected to occur during the predetermined period with respect to the at least one document, and determining a quality management index by which quality of the at least one document may be numerically expressed based on the number of the expected clicks and the number of the actual clicks.

### TECHNICAL FIELD

The present invention relates to a method and system for managing quality of an advertising document, and more particularly, to a method and system for managing quality of documents that may be provided on the Internet via the World Wide Web.

### BACKGROUND ART

Documents, such as web pages provided through a network may be provided for users through various methods. As an example, the users may access a desired document through a domain corresponding to the document, or using a search function, a link to the document, and a portal site. The portal site may refer to a site designed for the users to visit when the users access the Internet via the World Wide Web, which will be hereinafter referred to as the ‘Web’.

Administrators of the portal site may improve user satisfaction by providing high quality documents. However, there exist a considerably large number of documents on the Web, and it may be impossible to individually verify all of the documents. The present invention may provide a method and system for managing document quality that may effectively manage document quality that may be provided through the Web, for example, advertising documents.

### DISCLOSURE OF INVENTION

### Technical Goals

An aspect of the present invention provides a method and system for managing document quality that may determine a quality management index by which quality of a document may be numerically expressed based on a number of expected clicks and a number of actual clicks, and may manage quality of the document based on the quality management index.

An aspect of the present invention also provides a method and system for managing document quality that may classify a group of the document based on the quality management index, and may manage quality of the document based on a management strategy for each group, corresponding to the classified group.

### Technical Solutions

According to an aspect of the present invention, there is provided a method of managing document quality, including verifying a number of actual clicks corresponding to a number of clicks that may occur during a predetermined period with respect to at least one document that may exist on the Web, verifying a number of expected clicks corresponding to a number of clicks that may be expected to occur during the predetermined period with respect to the at least one document, and determining a quality management index by which quality of the at least one document may be numerically expressed based on the number of the expected clicks and the number of the actual clicks.

The number of the expected clicks may be calculated based on at least one field weight, among a number of clicks for each field, that may occur when the at least one document is provided through at least one field among a plurality of fields included on a search result page, and a field weight that may be predetermined with respect to each of the plurality of the fields.

The determining of the quality management index may include calculating the quality management index based on a ratio between the number of the expected clicks and the number of the actual clicks.

At least one document may be provided for a user according to a click event occurrence with respect to a link to the at least one document, and the link may be set on a search result page based on a keyword inputted by the user.

At least one document may include an advertising document of which exposure or non-exposure through a corresponding advertising area may be determined, based on a bidding price per unit time, inputted by an advertiser, and the bidding price per the unit time may include expected costs of the advertiser, that may be consumed for exposing the advertising document through a corresponding field among a plurality of fields corresponding to the advertising area, during at least one unit time.

The method of managing document quality may further include classifying the at least one document into a single group among a plurality of groups, based on the quality management index.

According to an aspect of the present invention, there is also provided a system for managing document quality, including a number of actual clicks verification unit to verify a number of actual clicks corresponding to a number of clicks that may occur during a predetermined period with respect to at least one document that may exist on the Web, a number of expected clicks verification unit to verify a number of expected clicks corresponding to a number of clicks that may be expected to occur during the predetermined period with respect to the at least one document, and a quality management index determiner to determine a quality management index by which quality of the at least one document may be numerically expressed based on the number of the expected clicks and the number of the actual clicks.

### Effect of the Invention

According to embodiments of the present invention, a low quality document may be selected and managed by determining a quality management index by which document quality may be numerically expressed based on a number of expected clicks and a number of actual clicks, and by managing the document quality based on the quality management index, and thereby the document quality may be constantly maintained, and search satisfaction of a user may be improved.

According to embodiments of the present invention, a low quality document may be selected and managed by classifying a group of the document based on the quality management index, and by managing the quality of the document based on a management strategy for each group corresponding to the classified group, and thereby the document quality may be constantly maintained, and search satisfaction of a user may be improved.

According to embodiments of the present invention, a low quality document may be selected and managed based on the quality management index or the management strategy for each group, and thereby the quality of the document may be constantly maintained, and search satisfaction of a user may be improved.

According to embodiments of the present invention, a fundamental problem with respect to malicious clicks by the same user or the same group may be resolved, by calculating advertising fees per unit time, based on a bidding price per unit time for each advertising area, rather than calculating the advertising fees based on clicks of advertisement.

### BRIEF DESCRIPTION OF DRAWINGS

FIG. 1 illustrates an example of a part of a search result page screen corresponding to a keyword that may be inputted by a user.

FIG. 2 illustrates a method of managing document quality according to an embodiment of the present invention.

FIG. 3 illustrates an example of a table including information with respect to a quality management index and groups.

FIG. 4 illustrates an example of a bidding price per unit time.

FIG. 5 illustrates an internal configuration of a system for managing document quality, according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

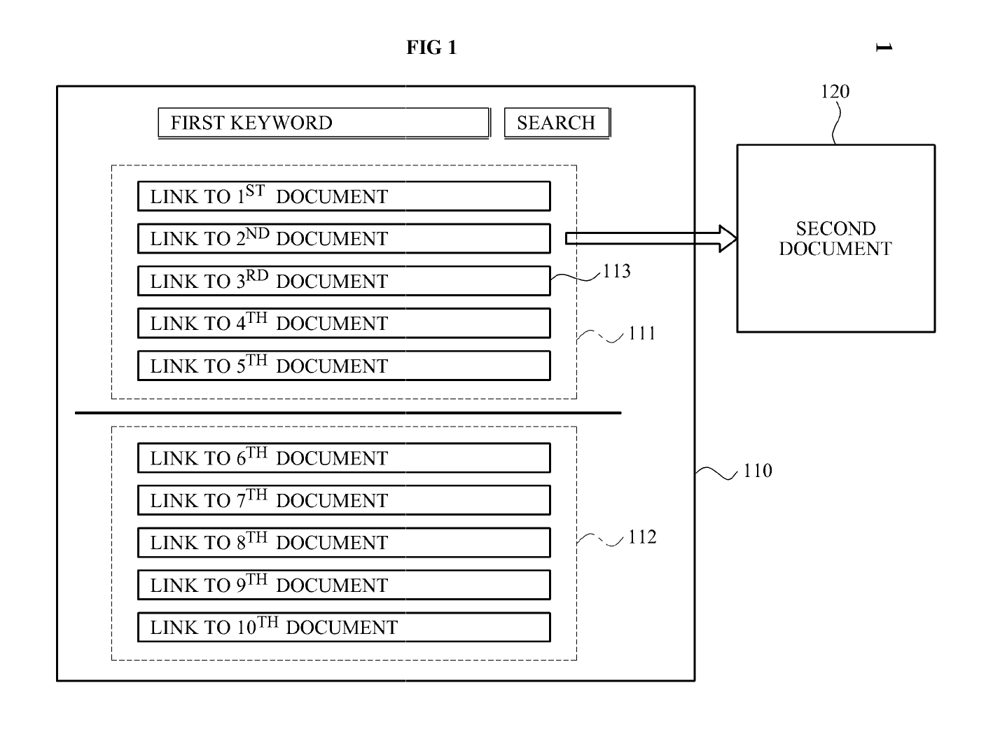

FIG. 1 illustrates an example of a part of a search result page screen corresponding to a keyword that may be inputted by a user. A search result page 110 may correspond to a search result with respect to a first keyword inputted by the user, and links to ten documents may be set on ten fields included in two areas, an area 111 and an area 112. For example, when a click event with respect to a link 113 to a second document 120 occurs by the user, the second document 120 may be provided for the user. The system for managing document quality may determine a quality management index by which quality of documents may be numerically expressed based on a number of clicks for each of the documents, measured based on a click event occurring with respect to each document. For example, the quality management index may be used to improve search satisfaction of the user by constantly maintaining the quality of the documents that may be provided as the search result. Here, the click event may indicate a mouse click event with respect to a link to a document, and also may include all user events for selecting the link to the document.

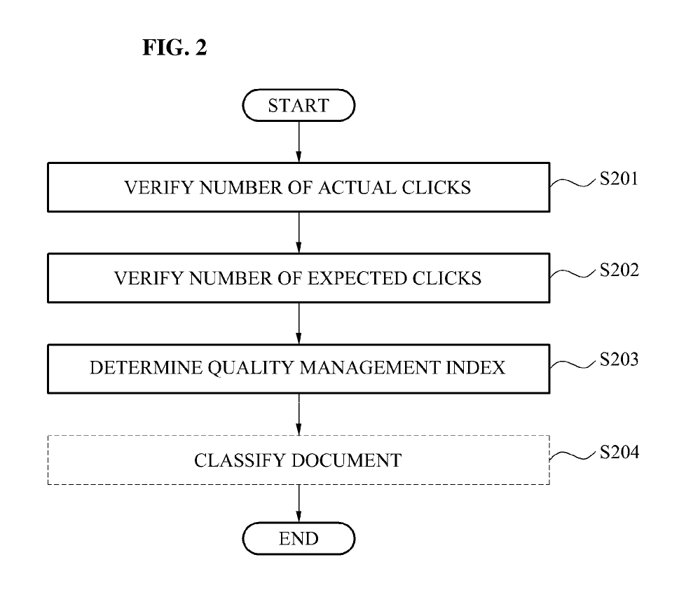

FIG. 2 illustrates a method of managing document quality according to an embodiment of the present invention. The method of managing document quality according to an embodiment of the present invention may be performed by the system for managing document quality as described with reference to FIG. 1. In FIG. 2, the method of managing document quality may be described by describing a process of performing each operation by the system for managing document quality.

In operation S201, the system for managing document quality may verify a number of actual clicks corresponding to a number of clicks that may occur during a predetermined period with respect to at least one document that may exist on the Web. The number of the clicks may indicate a number of times that a link to the at least one document may be selected through a user event on a web page on which the link to the at least one document may be set. For example, the number of the actual clicks may be measured based on a number of times that the link to the at least one document may be selected in recent n days, and the system for managing document quality may verify the number of the actual clicks corresponding to the measured number of times.

In operation S202, the system for managing document quality may verify a number of expected clicks corresponding to a number of clicks that may be expected to occur during the predetermined period with respect to the at least one document. The number of the expected clicks may be calculated based on at least one field weight, among a number of clicks for each field, that may occur when the at least one document is provided through at least one field among a plurality of fields included on a search result page, and a field weight that may be predetermined with respect to each of the plurality of the fields. Links with respect to the at least one document may be set on the plurality of the fields, as described with respect to FIG. 1, and the number of the expected clicks may be calculated based on the number of the clicks for each field in which a number of times that the link may be selected by the user event may be measured for each field, and based on the field weight with respect to a corresponding field. For example, when the at least one document has been exposed in a single field for 10 days, from July 13 to July 22, and the predetermined period corresponds to 10 days, from August 10 to August 19, a number of expected clicks with respect to the predetermined period may be calculated based on a number of clicks at the time when the at least one document has been exposed for 10 days, from July 13 to July 22, and a field weight with respect to the single field. When the at least one document has been exposed in at least two fields among the plurality of the fields, the number of the expected clicks may be calculated based on a number of clicks for each field that may be measured for each of the fields, and field weights of the corresponding fields. The field weight may be determined, based on a predetermined strategy, by the system for managing document quality or an administrator of the system for managing document quality, and may be applied to a number of clicks for each corresponding field through arithmetic operations such as a multiplication, an addition, and the like. The number of the expected clicks and the number of the actual clicks may be calculated or measured in the system for managing document quality, and also the calculated value or the measured value may be used in another system related to the system for managing document quality.

In operation S203, the system for managing document quality may determine a quality management index by which quality of the at least one document may be numerically expressed based on the number of the expected clicks and the number of the actual clicks. In this instance, the system for managing document quality may calculate the quality management index based on a ratio between the number of the expected clicks and the number of the actual clicks. For example, when a number of clicks that may actually occur with respect to the at least one document is less than a number of expected clicks, the quality of the at least one document may be judged to be relatively low. When the number of the clicks that may actually occur is greater than the number of the expected clicks, the quality of the at least one document may be judged to be relatively high or to be maintained greater than a standard. Accordingly, the system for managing document quality may determine the quality management index by adjusting the ratio using a predetermined invariable number or a predetermined function.

Also, the calculated quality management index may be used for managing the at least one document. For example, a higher quality document among documents that may be provided as a search result may be exposed on a top of a search result page, or only the document having quality greater than predetermined quality may be provided as the search result, and thereby a user who may generate the document may be induced to generate a higher quality document, and a search satisfaction of the user may be improved, which may also be equally applied to advertising documents for advertising. That is, an access of the user may be induced through a higher quality advertising document, and an effect of an advertisement may be improved from a viewpoint of the advertiser, and an advertising profit may be improved from a viewpoint of advertising media, by maintaining quality of an advertising product that may be proposed by the advertising media to be greater than a predetermined level from a long-term viewpoint. Also, in this instance, the document may include an advertising document of which exposure or non-exposure through a corresponding advertising area may be determined, based on a bidding price per unit time, inputted by the advertiser. The bidding price per the unit time may include expected costs of the advertiser, which may be consumed for exposing the advertising document through a corresponding field among a plurality of fields corresponding to the advertising area, during at least one unit time.

In operation 5204, the system for managing document quality may classify the at least one document into a single group among a plurality of groups, based on the quality management index. The at least one document may be managed through a management strategy for each group corresponding to the group where the at least one document may be classified, among a plurality of management strategies for each group, and at least one management strategy for each group among the plurality of the management strategies for each group may include a management strategy for each group that may limit an exposure of the at least one document. For example, an entire document may be classified into ten groups based on the quality management index, and different strategies may be applied for each of the groups. Here, an exposure of the document may be limited in at least one group. Operation 5204 has been disclosed as an example of using the determined quality management index, which may be omitted as necessary.

Also, when the at least one document includes an advertising document, the system for managing document quality may further perform exposing (not shown) a relative index value that may be determined for each group corresponding to the advertising document, and for each of the plurality of the groups, through an advertiser page where the advertising document may be registered, in order to provide the advertiser with relative quality information with respect to his own advertising document.

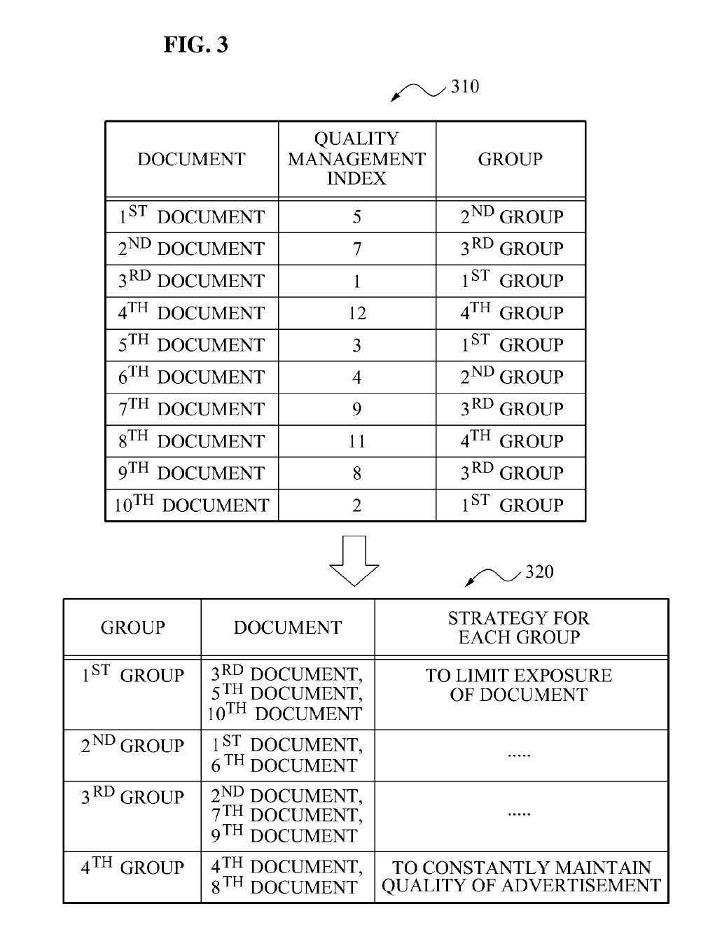

FIG. 3 illustrates an example of a table including information with respect to a quality management index and groups. Table 310 may include information with respect to the quality management index with respect to ten documents, and information with respect to the groups classified based on the quality management index. The quality management index may be numerically expressed using an integer value between 1 and 12, and may represent an example where the documents may be classified into four groups at an equal interval with respect to the quality management index. Table 320 may include, for each group, information with respect to documents included in each of the groups, and information with respect to management strategies for each group with respect to the documents. In FIG. 3, an example may be represented, where an exposure of a corresponding document may be limited with respect to the documents that may have a relatively, extremely low quality management index, and may be classified as a first group, for example, a third document, a fifth document, and a tenth document.

According to the method of managing document quality, when the quality management index, in which quality with respect to at least one document may be numerically expressed, is determined, the at least one document may be more precisely managed based on the quality management index. For example, the quality management index may be used, as an objective index, for an analysis of a cause of decrease in advertising quality with respect to an advertising document having the quality management index included in a predetermined range, for a quality improvement consultation with an advertiser, or for encouraging the advertiser to improve the advertising document or an advertisement copy.

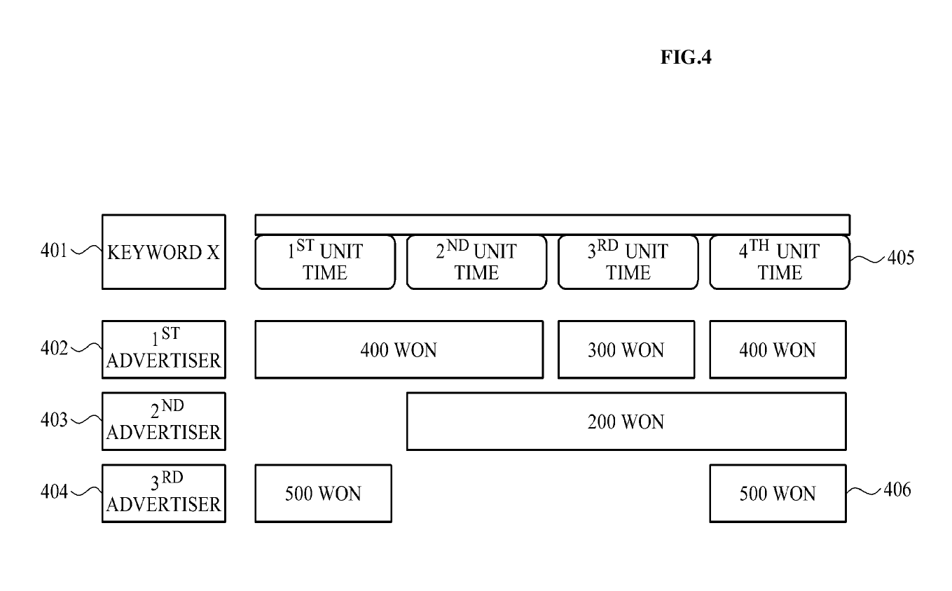

FIG. 4 illustrates an example of a bidding price per unit time. The bidding price per the unit time may refer to a bidding price with respect to a unit time, rather than a bidding price with respect to clicks. The example of FIG. 4 may indicate a bidding price per unit time that may be inputted with respect to a keyword X 401, by a first advertiser 402, a second advertiser 403, and a third advertiser 404. For example, the first advertiser 402 may have suggested a bidding price for a unit time, respectively 400 Korean won with respect to a first unit time and a second unit time, 300 Korean won with respect to a third unit time, and 400 Korean won with respect to a fourth unit time 405. When it is assumed that sales with respect to a corresponding unit time may be made simply based on only a bidding price per unit time, an advertisement of the third advertiser 404 who suggested a bidding price per unit time of 500 Korean won 406 which may be the highest with respect to the fourth unit time 405 may be exposed with respect to the keyword X 401 during the fourth unit time 405.

A ‘unit time’ in the present disclosure may refer to a time from a predetermined start time to a predetermined end time. The ‘unit time’ may include all necessary information, for example, a year, a month, a day, an hour, a minute, and a second, however, the present disclosure may use the information of only the hour or the minute for ease of description. Also, the predetermined time with respect to an advertising area where a predetermined keyword or document exposed may be determined as necessary by a system providing an advertisement, an administrator of the system, or an advertiser. The system may include a system for managing document quality according to embodiments of the present invention, or may be related to the system for managing document quality. For example, the system may classify a day into 48 unit times in total at intervals occurring every thirty minutes, with respect to a single advertising area, and may determine effective values with respect to each of the 48 unit times. The effective values may correspond to a criterion that may indicate effective information of a corresponding advertising area during a corresponding unit time, and for example, the lowest cost consumed for using the corresponding advertising area during the corresponding unit time may be used as the effective values.

Also, the advertiser may purchase the corresponding advertising area so that his own advertisement may be exposed through the corresponding advertising area during a desired unit time among the 48 unit times, for example, a unit time between twelve thirty in the afternoon and one o'clock in the afternoon, and a unit time between three o'clock in the afternoon and three thirty in the afternoon. The advertising area may be purchased based on the unit time and the effective values according to the unit time, and thereby the advertiser may efficiently obtain an advertising effect at a reasonable price. An advertising fee may be calculated for each unit time based on a bidding price per unit time according to a keyword and an advertising area, rather than clicks with respect to an advertising document, and accordingly a fundamental problem with respect to malicious clicks by the same user or the same group may be resolved.

The effective values may be determined based on a bidding target keyword that the advertiser may bid for. For example, effective values with respect to a unit time of a bidding target keyword, that is, a period when an advertisement may be exposed, may be determined based on data associated with a number of times of searching for the bidding target keyword, and a number of advertisement clicks using the bidding target keyword. In this instance, an advertising fee and an advertisement exposure priority with respect to a single advertising document during the unit time may be maintained to be fixed. Also, the effective values with respect to the unit time of the bidding target keyword may be calculated based on advertising history information of the bidding target keyword. The advertising history information may include at least one of all measurable information with respect to the bidding target keyword, such as a number of clicks, a unit price of click, a number of hits, a number of exposures, or a number of product purchases. For example, an average unit price of clicks of a bidding target keyword, and an average number of clicks corresponding to a unit time when an advertisement may be exposed may be used as the advertising history information.

The lowest bidding price of the bidding target keyword may be determined based on the effective value. For example, in a case of a keyword bidding for exposing an advertisement during a ‘7 day’ unit time, the lowest bidding price of the bidding target keyword may be determined to be “an average unit price of clicks X an average number of expected clicks for 7 days.”

In an advertisement bidding for an advertising document, an advertisement may be provided by inducing advertisers to make a bid by determining effective values for each advertising area, or by inducing the advertisers to perform a keyword bidding by determining effective values with respect to a bidding target keyword, and then by determining priority of the advertisers in order of the highest suggested bidding price. For example, advertisements of advertisers from a first place to a fifth place based on the bidding price may be respectively provided through five advertising areas. The priority of the advertisers may be determined in the order the highest suggested bidding price, however, actual payment costs of the advertisers may be determined based on a bidding price of the next place advertiser. In this instance, the actual payment costs of the advertisers may be determined to be equal to the bidding price of the nest place advertiser, however unlikely, a price calculated by adding a minimum bidding adjustment unit to the bidding price of the next place advertiser may be determined to be the actual payment costs. For example, the actual payment costs may be determined as “actual payment cost=bidding price of next price advertiser+minimum bidding adjustment unit.”

The minimum bidding adjustment unit may correspond to a value that may be freely set by an administrator who may operate a system for providing an advertisement to be described, and may be a factor for adjusting an actual payment cost of an advertiser to be a cost infinitesimally greater than a bidding price of a next place advertiser.

As an example, the minimum bidding adjustment unit may be determined based on a bidding price unit of an advertiser. For example, when the minimum bidding adjustment unit is determined to be 1/100 of the bidding price unit of the advertiser, if the bidding price of the advertiser corresponds to a one hundred-thousand Korean won unit, the minimum bidding adjustment unit may correspond to 1,000 Korean won, and if the bidding price of the advertiser corresponds to a ten-thousand Korean won unit, the minimum bidding adjustment unit may correspond to 100 Korean won. The following Table 1 may be referred to for ease of understanding in this regard.

TABLE 1

| Exposure | Bidding price | |
|---|---|---|
| priority | (Unit: Korean won) | Actual payment cost |
| 1^{st} place | 101,000 won | 10,100 won + 1,000 won |
| 2^{nd} place | 10,100 won | 9,010 won + 100 won |
| 3^{rd} place | 9,010 won | Bidding price of next place advertiser + |
| | | minimum bidding adjustment unit |

An example of a keyword bidding scheme of an advertiser will be further described. Although the following description with respect to a date, a day, and time will be hereinafter described as examples only, various dates, days, times, or other changed forms thereof may be used.

\textcircled{1} Regular Bid

A regular bid may be closed every Wednesday at three o'clock in the afternoon, and an advertisement may be exposed for 7 days from midnight of the next day, Thursday, according to a successful bidding result. The bidding result may be notified to an advertiser by e-mail, mobile phone message, and the like. The next regular bid may start just after the Wednesday three o'clock in the afternoon bid is closed, and accordingly the advertiser may participate in the next regular bid even when the advertiser fails.

\textcircled{2} Occasional Bid

An occasional bid, that is, an additional bid for a number of remaining disclosure days (7-days) may be performed every day with respect to unsold keywords or keywords of which disclosure may be canceled. When there is a keyword that should be exposed, even during a short period, the advertiser may expose an advertisement through the occasional bid after the regular bid is closed. Information with respect to a number, a type, and the like of the unsold keywords or the keywords of which disclosure may be canceled may be provided through an advertisement managing page so that the advertiser may participate in the occasional bid.

\textcircled{3} Automatic Bid

An automatic bid function may enable a convenient advertisement management for an advertiser who may desire to execute a keyword advertisement by minimizing a cost for managing the advertisement. The advertiser who may use the automatic bid may manage an advertisement for each advertising group, and may automatically participate in a regular bid, without inconvenience of verifying whether a bid is on using a bid ON/OFF function, and using an additional bid participation option. When the advertiser uses the additional bid participation option, an automatic participation in an occasional bid which may occur for various reasons may be possible.

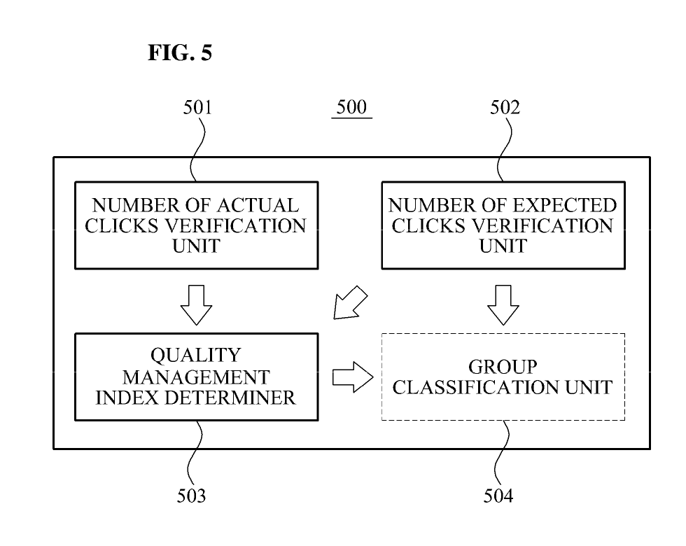

FIG. 5 illustrates an internal configuration of a system 500 for managing document quality, according to an embodiment of the present invention. The system 500 for managing document quality may include a number of actual clicks verification unit 501, a number of expected clicks verification unit 502, and a quality management index determiner 503. Also, the system 500 for managing document quality may further include a group classification unit 504 as necessary.

The number of actual clicks verification unit 501 may verify a number of actual clicks corresponding to a number of clicks that may occur during a predetermined period with respect to at least one document that may exist on the Web. The number of clicks may refer to a number of times that a link to the at least one document may be selected through a user event on a web page on which the link to the at least one document may be set. For example, the number of the actual clicks may be measured as a number of times that the link to the at least one document may be selected in recent n days, and the number of actual clicks verification unit 501 may verify the number of the actual clicks corresponding to the measured number of times. The measurement of the number of the actual clicks may be performed directly in the system 500 for managing document quality, and also a value measured in a separate system related to the system 500 for managing document quality may be used.

The number of expected clicks verification unit 502 may verify a number of expected clicks corresponding to a number of clicks that may be expected to occur during the predetermined period with respect to the at least one document. The number of the expected clicks may be calculated based on at least one field weight, among a number of clicks for each field, that may occur when the at least one document is provided through at least one field among a plurality of fields included on a search result page, and a field weight that may be predetermined with respect to each of the plurality of the fields. Links with respect to the at least one document may be set on the plurality of the fields, as described with respect to FIG. 1, and the number of the expected clicks may be calculated based on a number of clicks for each field in which a number of times that the link may be selected by the user event may be measured for each field, and a field weight with respect to a corresponding field.

For example, when the at least one document has been exposed in a single field for 10 days, from July 13 to July 22, and the predetermined period would correspond to 10 days, from August 10 to August 19, a number of expected clicks with respect to the predetermined period may be calculated based on a number of clicks at the time when the at least one document has been exposed for 10 days, from July 13 to July 22, and a field weight with respect to the single field. When the at least one document has been exposed in at least two fields among the plurality of the fields, the number of the expected clicks may be calculated based on a number of clicks for each field that may be measured for each of the fields, and field weights of the corresponding fields. The field weight may be determined, based on a predetermined strategy, by the system 500 for managing document quality or an administrator of the system 500 for managing document quality, and may be applied to a number of clicks for each corresponding field through arithmetic operations such as a multiplication, an addition, and the like. That is, the number of expected clicks verification unit 502 may verify the calculated number of the expected clicks. The number of the expected clicks may be calculated in the system 500 for managing document quality, and may be calculated using a value calculated in a system related to the system 500 for managing document quality.

The quality management index determiner 503 may determine a quality management index by which quality of the at least one document may be numerically expressed based on the number of the expected clicks and the number of the actual clicks. The quality management index determiner 503 may calculate the quality management index based on a ratio between the number of the expected clicks and the number of the actual clicks. For example, when a number of clicks that may actually occur with respect to the at least one document is less than a number of expected clicks, the quality of the at least one document may be judged to be relatively low. When the number of the clicks that may actually occur is greater than the number of the expected clicks, the quality of the at least one document may be judged to be relatively high or to be maintained to be greater than a standard. Accordingly, the system 500 for managing document quality may determine the quality management index by adjusting the ratio using a predetermined invariable number or a predetermined function.

Also, the calculated quality management index may be used for managing the at least one document. For example, a higher quality document among documents that may be provided as a search result may be exposed on a top of a search result page, or only the document having quality greater than predetermined quality may be provided as the search result, and thereby a user who may generate the document may be induced to generate a higher quality document, and a search satisfaction of the user may be improved, which may also be equally applied to advertising documents for advertising. That is, an access of the user may be induced through a higher quality advertising document, and an effect of the advertisement may be improved from a viewpoint of the advertiser, and an advertising profit may be improved from a viewpoint of a media, by maintaining quality of an advertising product proposed by the advertising media to be greater than a predetermined level from a long-term viewpoint. Also, in this instance, the at least one document may include an advertising document of which exposure or non-exposure through a corresponding advertising area may be determined, based on a bidding price per unit time inputted by the advertiser. The bidding price per the unit time may include expected costs of the advertiser, which may be consumed for exposing the advertising document through a corresponding field among a plurality of fields corresponding to the advertising area, during at least one unit time.

The group classification unit 504 may classify the at least one document into a single group among a plurality of groups, based on the quality management index. The at least one document may be managed through a management strategy for each group corresponding to the group where the at least one document may be classified, among a plurality of management strategies for each group, and at least one management strategy for each group among the plurality of the management strategies for each group may include a management strategy for each group that may limit an exposure of the at least one document. For example, an entire document may be classified into ten groups based on the quality management index, and different strategies may be applied for each of the groups. Here, an exposure of the document may be limited in at least one group. As aforementioned, the group classification unit 504 has been disclosed as an example of using the determined quality management index, which may be optionally included in the system 500 for managing document quality as necessary.

When using a method or system for managing document quality according to embodiments of the present invention, a low quality document may be selected and managed by determining a quality management index by which quality of a document may be numerically expressed based on a number of expected clicks and a number of actual clicks, and by managing the quality of the document through the quality management index, and thereby the quality of the document may be constantly maintained, and a search satisfaction of a user may be improved.

Also, a low quality document may be selected and managed by classifying a group of the document through the quality management index, and by managing the quality of the document through a management strategy for each group corresponding to the classified group, and thereby quality of the document may be constantly maintained, and a search satisfaction of a user may be improved.

Additionally, a low quality document may be selected and managed based on the quality management index or the management strategy for each group, and thereby quality of the document may be constantly maintained, and a search satisfaction of a user may be improved.

Further, a fundamental problem with respect to malicious clicks by the same user or the same group may be resolved, by calculating advertising fees per unit time, based on a bidding price per unit time for each advertising area, rather than calculating the advertising fees based on clicks of advertisement.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of managing document quality, the method comprising:
verifying a number of actual clicks corresponding to a number of clicks that occur during a predetermined period with respect to at least one document that exists on the Web;
verifying a number of expected clicks corresponding to a number of clicks that are expected to occur during the predetermined period with respect to the at least one document; and
determining a quality management index by which quality of the at least one document is numerically expressed based on the number of the expected clicks and the number of the actual clicks.

2. The method of claim 1, wherein the number of the expected clicks is calculated based on at least one field weight, among a number of clicks for each field, that occurs when the at least one document is provided through at least one field among a plurality of fields included on a search result page, or a field weight that is predetermined with respect to each of the plurality of the fields.

3. The method of claim 1, wherein the determining a quality management index comprises:
calculating the quality management index based on a ratio between the number of the expected clicks and the number of the actual clicks.

4. The method of claim 1, wherein
the at least one document is provided for a user according to a click event occurrence with respect to a link to the at least one document, and
the link is set on a search result page based on a keyword inputted by the user.

5. The method of claim 1, wherein
the at least one document comprises an advertising document of which exposure or non-exposure through a corresponding advertising area is determined, based on a bidding price per unit time, inputted by an advertiser, wherein
the bidding price per the unit time comprises expected costs of the advertiser, and the expected costs is consumed for exposing the advertising document through a corresponding field among a plurality of fields corresponding to the advertising area during at least one unit time.

6. The method of claim 1, further comprising:
classifying at least one document into a single group among a plurality of groups based on the quality management index.

7. The method of claim 6, wherein
the classified at least one document is managed through a management strategy for each group corresponding to a group among a plurality of management strategies for each group, and
at least one management strategy for each group among the plurality of the management strategies for each group comprises a management strategy for each group that limits an exposure of the at least one document.

8. The method of claim 6, further comprising:
exposing a relative index value that is determined for each group corresponding to an advertising document, and for the plurality of the groups, through an advertiser page where the advertising document is registered,
wherein at least one document comprises the advertising document.

9. A non-transitory computer-readable medium comprising a program for instructing a computer to perform the method of any one of claim 1 through claim 8.

10. A system for managing document quality, the system comprising:
a number of actual clicks verification unit to verify a number of actual clicks corresponding to a number of clicks that occur during a predetermined period with respect to at least one document that exists on the Web;
a number of expected clicks verification unit to verify a number of expected clicks corresponding to a number of clicks that are expected to occur during the predetermined period with respect to the at least one document; and
a quality management index determiner to determine a quality management index by which quality of the at least one document is numerically expressed based on the number of the expected clicks or the number of the actual clicks.

11. The system of claim 10, wherein the number of the expected clicks is calculated based on at least one field weight, among a number of clicks for each field, that occur when the at least one document is provided through at least one field among a plurality of fields included on a search result page, or a field weight that is predetermined with respect to each of the plurality of the fields.

12. The system of claim 10, wherein the quality management index determiner is configured to calculate the quality management index based on a ratio between the number of the expected clicks and the number of the actual clicks.

13. The system of claim 10, wherein
the at least one document is provided for a user according to a click event occurrence with respect to a link to the at least one document, and
the link is set on a search result page based on a keyword inputted by the user.

14. The system of claim 10, wherein
the at least one document comprises an advertising document of which exposure or non-exposure through a corresponding advertising area is determined based on a bidding price per unit time, inputted by an advertiser, and
the bidding price per the unit time comprises expected costs of the advertiser, and the expected costs is consumed for exposing the advertising document through a corresponding field among a plurality of fields corresponding to the advertising area during at least one unit time.

15. The system of claim 10, further comprising:
a group classification unit to classify the at least one document into a single group among a plurality of groups based on the quality management index.
